(19) United States
(12) Patent Application Publication
(10) Pub. No.: US 2014/0063193 A1
(43) Pub. Date: Mar. 6, 2014

(54) Natural 3D Motion For Film And Video

(71) Applicant: Wayne Martin Williams, Sherman Oaks, CA (US)

(72) Inventor: Wayne Martin Williams, Sherman Oaks, CA (US)

(21) Appl. No.: 14/017,267

(22) Filed: Sep. 3, 2013

Related U.S. Application Data
(60) Provisional application No. 61/696,133, filed on Aug. 31, 2012.

(51) Int. Cl. H04N 13/02

(52) U.S. Cl. CPC H04N 13/0282
USPC 348/46

(57) ABSTRACT

“Natural 3D Motion” is created by the use of moving the camera in a lateral direction with foreground and background elements, at a consistent speed, throughout a scene, in such a way that it allows the viewer time to perceive three dimensional depth and experience immersion in the scene without the use of 3D glasses, 3D Projectors or 3D Video Displays. Its beneficial affects, depending upon the nature of the video/film/movie, including enhancing a sense of calm, especially when the scenes comprise peaceful images beyond the traditional film or movie experience. Additionally, the presentation of “Natural 3D Motion” film/movies can be viewed without the need for the viewer to sit through an entire film/movie as the experience of three dimensional depth can capture the viewer's imagination and provide a calming effect while viewing even a portion of a full “Natural 3D Motion” film or movie.

### CROSS-REFERENCE TO RELATED APPLICATIONS

This application claims the benefit of U.S. Provisional Application No. 61/696,133, filed on Aug. 31, 2012, the contents of which are incorporated by reference as if fully set forth herein.

### FIELD OF THE INVENTION

The present invention generally relates to motion pictures, and more particularly, preferred embodiments of the invention relate to a system for creating a motion picture with depth effects.

### BACKGROUND OF THE INVENTION

In the realm of visual film and video imagery, creating the perception of three dimensional depth on a projected or displayed visual platform requires specialized or additional 3D apparatuses such as 3D televisions, 3D glasses or 3D projectors, and typically requires multiple cameras to create the effect. The additional apparatuses and using multiple cameras adds cost to the production and deployment of the motion picture content.

It is desirable to have a process for creating a motion picture with the perception of three dimensional depth without such added costs and with further benefits.

### BRIEF SUMMARY OF PREFERRED EMBODIMENTS OF THE INVENTION

“Natural 3D Motion” creates the perception of three dimensional depth on a projected or displayed visual platform, such as a film or video screen display using contemporary displays without the need for additional apparatus such as 3D Televisions, 3D glasses or 3D Projectors, and does not require shooting film or video with multiple cameras to create the effect.

“Natural 3D Motion” is the process of recording a scene in a visual environment using the elements of slowly and steadily moving the camera recording device in a consistent lateral motion, in association with visually included and well-defined foreground elements and associated background elements. This process, when used to record a scene over a limited period of time, produces a motion picture that when viewed on a display, allows the viewers' perception of depth to be realized and experienced. One continuously filmed scene, in association with subsequent additional scenes in an ongoing sequence of scenes, creates a film or video end product. The long duration of each continuously recorded scene provides a peaceful and calming effect on the viewer.

“Natural 3D Motion” is preferably recorded in High Definition video or High Resolution film formats with a true non-distorting wide-angle lens with shutter rates between 24, 30 or 60 frames per second so as to create a motion picture that provides a calming and peaceful viewing experience.

### BRIEF DESCRIPTION OF THE DRAWINGS

Preferred embodiments of the present invention are illustrated by way of example, and not by way of limitation, in the figures of the accompanying drawings and in which like reference numerals refer to similar elements and in which:

FIG. 1 is a diagrammatic view of a system for creating natural 3D motion for film and video, in accordance with some embodiments of the invention.

FIG. 2 is a flow diagram illustrating a process of creating natural 3D motion for film and video, in accordance with some embodiments of the invention.

### DETAILED DESCRIPTION OF PREFERRED EMBODIMENTS OF THE INVENTION

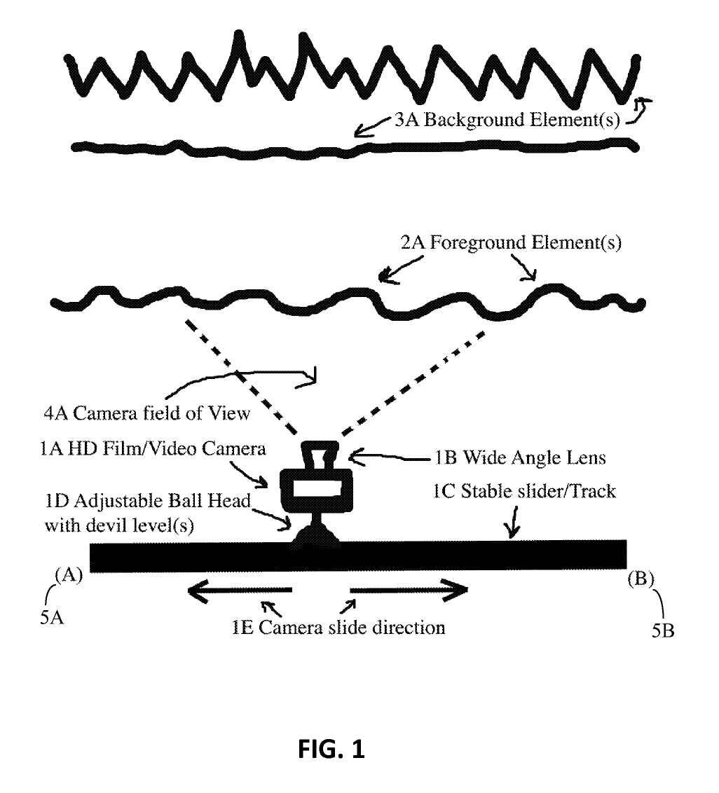

Referring to FIG. 1, a single camera video or film shooting process captures a scene with perceived natural 3D motion without needing multiple cameras. A motion picture captured by the process creates the impression of three-dimensional depth without the viewer requiring colored or polarized 3D lenses. In some embodiments, a camera 1A moves at a consistent speed in one direction 1E across the scene having foreground elements 2A and background elements 3A. In a motion picture captured by this method, the mind's eye of the viewer has time to shift back and forth between foreground and background in such a manner as to experience depth within the scene.

In this process a foreground element 2A is established which appears to move within the scene at a consistent and comfortable speed for the viewer, and causes the viewer to observe depth and to observe the two-dimensional scene as being three-dimensional. The linking together of multiple peaceful “Natural 3D Motion” scenes may additionally create a user experience that calms the viewer's mind, lowers heart rate and blood pressure in the process.

To capture the effect of “Natural 3D Motion,” a camera is mounted on a stable platform 1C. Examples of such a platform includes but is not limited to a slider, a jib, a boom, a steady cam device, or an aircraft, or other platform that can provide a lateral direction of motion at a consistent speed for a minimum of 15 to a maximum of 120 seconds. In some embodiments, the motion of the camera moves laterally in a straight line. In some embodiments, the camera's field of view captures at least one foreground element 2A that is perceived to move across the scene as camera 1A moves in a consistent manner on platform 1C. Camera 1A's field of view 4A captures background elements 3A that are as expansive as possible, with a wide angle view from wide angle lens 1B. In some preferred embodiments, when a viewer views a scene captured by this process, the viewer's eyes continually have the area to shift his or her gaze between the foreground elements 2A and background elements 3A, and thus the motion picture provides the illusion of depth.

Camera 1A is moved at a speed that is slow enough to not drive a viewer to only observe the background 3A due to excessively fast movement of foreground elements 2A.

Multiple scenes using the process of “Natural 3D Motion” described above enhance the viewer's experience of perceived three-dimensional depth where the entire video/film/movie consists only of scenes using the process. Films can run in lengths of 5 to 200 minutes and can be looped together in batches to create unlimited moving artworks for video or film displays.

With further reference to FIG. 1, according to some preferred embodiments, the process of recording a scene includes the following elements:

1. At least a foreground element 2A of focus within the visual scene being shot. Foreground element 2A is to be within one foot to fifty feet from the camera position. This object or surface may include a ground surface of dirt, flowers, plants or other objects relative and consistent with the scene in view.

2. At least one background element 3A, which provides a distant point of focus within the scene, such as a landscape. In some embodiments, background element 3A begins at and continues beyond the foreground element 2A as seen from camera 1A.

3. The entire scene is viewed as a wide-angle, non-distorted visual landscape, where all elements within the scene are in relatively, if not actual, sharp focus.

4. A motion slide or drift along a tangent straight line (1E) by the camera 1A from point A 5A to point B 5B using a stable slider/track device 1C, such as a slider, boom, jib or other means. The motion allows the foreground element 2A to provide perceived motion depth to a viewer as the camera 1A moves laterally across the scene while maintaining the same background 3A distant point of focus, or such that changes to the distant point of focus is minimized. In some embodiments, camera 1A is level, while the motion or movement is not level. This movement can be left to right, right to left, slanting upwards or downwards, vertical or horizontal, all while maintaining a foreground element 2A within the scene. The foreground element 2A need not be at the base of the scene, and multiple foreground elements 2A can be used to enhance the perceived depth of the scene captured during the camera 1A movement.

5. In some preferred embodiments, the speed of the slide or drift of camera 1A within normal wide-angle scenes is approximately ten seconds per each one foot of camera travel when foreground elements are beyond three feet from the camera. Where foreground elements 2A are closer to the camera 1A, such as close-ups of flowers, camera 1A moves a shorter distance at slower speeds than when the foreground elements 2A are farther away from camera 1A. For example, to capture a scene with a foreground element or elements 1A at a distance of one foot from the camera, camera 1A would travel at approximately one foot in 40 seconds along stable slider/track 1C moving in one direction 1E. This speed for close-ups is considerably slower than for capturing a panorama landscape, as previously described. The movement 1E remains consistent throughout the scene. In some embodiments, a slow-moving electric motor is used when camera is tracked. In some embodiments, a user uses the process by manually sliding or moving the camera 1A by hand along stable slider/track 1C, whether on a slider, jib or boom. In some embodiments, a slider track 1C has a length of five feet, which is sufficient to create a 40- to 50-second “Natural 3D motion” scene at ground level. The scene can be edited in post-production to a longer or shorter scene, whether cut in real time or slowed down by speeding up the frame-rate of the footage.

6. Camera 1A is stabilized on a stable slider/track 1C, such as a slider track, a boom/jib, or a steady-cam-type platform, to allow the slow movement of the camera to be consistent throughout the shot. A slow-moving helicopter with a stabilized camera platform can also create the “Natural 3D Motion” effect, as long as the move is slow enough, and a foreground element 2A and background element 3A are present in the scene that camera 1A captures from the aircraft. If a camera slider platform is used, it can be placed directly on the ground or elevated with the support of stable surfaces or tripods.

7. In some embodiments, the camera visual perspective is horizontal, and a leveling device, such as one that measures rise and degree of elevation, like a Pickett Devil Level, or a spirit or bubble level, is used to monitor and to set the roll, pitch, and yaw of the camera to avoid curving or sloping horizon perspectives. In order to achieve this leveling of the camera, the camera may be mounted on a ball head device 1D with a leveling device that is centered, using the ability of the ball head 1D to adjust the camera angle to always be level with the horizon and remain stable during the entire camera move of the scene. The camera's lens is facing a direction perpendicular to slider/tracker 1C.

8. In some embodiments, the duration of a scene captured by the process is between ten seconds and one minute. Where many scenes are combined to create a lengthier motion picture sequence of “Natural 3D Motion,” at the end of the scene, the scene dissolves into another “Natural 3D Motion” scene. The extended length of the duration provides a calming effect on a human viewer.

9. In some embodiments, ambient stereo or surround sound recording of each scene is not required for the overall perception of three-dimensional depth when viewing the scene. However, when presented with appropriate ambient sound of a scene, the viewer's experience of immersion and depth is enhanced. As such, in some embodiments, a scene is presented with an audio track recorded with ambient stereo or surround sound of the natural environment whenever possible. It may be necessary to record audio from a comparable location as some locations may not have appropriate sound available at time of shooting.

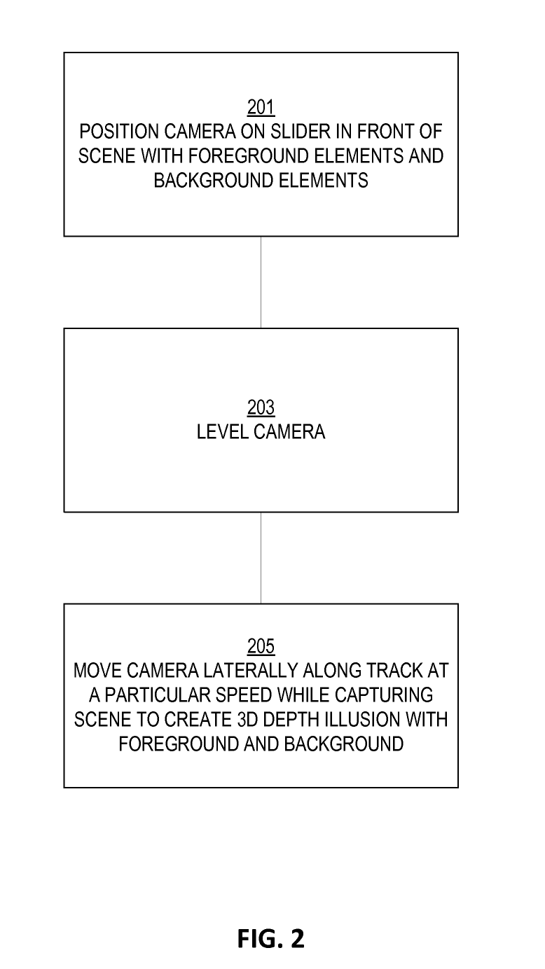

FIG. 2 is a flow diagram illustrating a process for creating a motion picture with a natural 3D motion effect, according to some embodiments. At step 201, a camera is positioned on a stable slider/track device, in front of a visual scene with foreground elements and background elements. In some embodiments, the foreground elements are within one foot to fifty feet from the camera position. This object or surface may include a ground surface of dirt, flowers, plants or other objects relative and consistent with the scene in view. The background element has a distant point of focus within the scene, such as a landscape, the begins at, and continues beyond the foreground element as seen from the camera. In some embodiments, the camera is positioned on the slider with enough room to allow the camera to move in one direction to complete a continuous shot. In some embodiments, the entire scene is viewed as a wide-angle, non-distorted visual landscape location, where all elements within the scene are in relatively if not sharp focus. In some embodiments, the slider is positioned generally parallel to the background scene such that the focal distance of a camera on the slider to the background scene remains relatively constant, or such that any change in the focal distance is minimized, throughout the length of the slider.

At step 203, the camera is leveled to avoid curving or sloping horizon perspectives within the frame of the captured images. In some embodiments, in any movement of the camera while the scene is captured, the camera maintains a horizontal level.

At step 205, the camera captures a scene while moving laterally along the slider track. The speed of the movement is such that the scene produces the 3D effect. The speed is dependent on the distance of the camera from the foreground element. Where the foreground elements 2A are closer to the camera 1A, such as close-ups of flowers, camera 1A moves a shorter distance at slower speeds than when the foreground elements 2A are farther away from camera 1A. For example, to capture a scene with a foreground element or elements 1A at a distance of one foot from the camera, camera 1A would travel at approximately one foot in 40 seconds along stable slider/track 1C moving in one direction 1E. In contrast, the speed of the slide or drift of camera 1A within normal wide-angle scenes is approximately ten seconds per each one foot of camera travel when foreground elements are beyond three feet from the camera. A motor may be used to maintain movement at a constant speed during the capturing of the scene by the camera.

As an alternative to a track, a camera may capture lateral movement from moving aircraft, such as on a helicopter.

The “Natural 3D Motion” provides the advantages of creating the perception of natural three-dimensional depth in a video/film/movie which is presented without 3D viewing devices, such as 3D projectors, 3D monitors, 3D glasses or other devices currently used to create and show films having a depth effect. The use of “Natural 3D Motion” in a video/film/movie makes possible the presentation of a 3D video/film/movie experience in any environment where a high definition video/film display is used. “Natural 3D Motion” video/film/movies create an immersive and calming 3D experience for the viewer.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. A method for creating a motion picture having an effect of depth, comprising the steps of:
positioning a camera in front of a scene, the scene having one or more foreground elements at a first distance from the camera, and the scene having one or more background elements at a second distance from the camera, the second distance greater than the first distance;
adjusting one or more of roll, pitch, or yaw of the camera such that the camera is level horizontally and pointed in a direction that is substantially perpendicular to a direction of travel;
capturing a motion picture of a scene while moving the camera in the direction of travel, wherein the moving occurs at a speed such that the motion picture captured at said speed provides a three-dimensional visual effect to a human viewer.

2. The method of claim 1, wherein the motion picture captured at said speed further causes a calming effect on the human viewer viewing the motion picture.

3. The method of claim 2, wherein the motion picture captured at said speed is of a duration of at least 10 seconds to one minute to cause the calming effect on the human viewer viewing the motion picture.

4. The method of claim 1, wherein positioning the camera includes mounting the camera on a stable straight track.

5. The method of claim 1, wherein positioning the camera includes mounting the camera on an aircraft.

6. The method of claim 1, wherein moving the camera includes using a motor to move the camera at a constant speed.

7. The method of claim 1, wherein said speed is within a range of approximately one foot per ten seconds when the first distance of the foreground elements from the camera are over three feet.

8. The method of claim 1, wherein said speed is within a range of approximately one foot per forty seconds when the first distance of the foreground elements from the camera is one foot.

9. The method of claim 1, wherein the capturing captures a wide-angle view through a non-distorting wide-angle lens.

10. The method of claim 1, wherein foreground elements include one or more of a surface, such as a ground surface, or one or more objects, and wherein background elements include a landscape.

11. The method of claim 1, wherein the moving is not level, while the camera is level.

12. The method of claim 1, wherein a plurality of motion pictures of one or more continuously captured scenes are combined to create a combined motion picture having the effect of depth.

13. The method of claim 1, further comprising the step of showing the motion picture to the viewer, wherein the motion picture causes the viewer to experience the three-dimensional visual effect without the use of 3D viewing devices.

14. A motion picture providing a visual depth effect to a viewer, the motion picture created by the process having the steps of:
positioning a camera in front of a scene, the scene having foreground elements at a first distance from the camera, and the scene having background elements at a second distance from the camera, the second distance greater than the first distance;
adjusting one or more of roll, pitch, or yaw of the camera such that the camera is level horizontally and pointed in a direction that is substantially perpendicular to a direction of travel;
capturing the motion picture of a scene while moving the camera in the direction of travel, wherein the moving occurs at a speed such that the motion picture captured at said speed provides a three-dimensional visual effect to a human viewer.

15. The motion picture of claim 14, wherein the motion picture captured at said speed causes a calming effect on the human viewer viewing the motion picture.

16. The motion picture of claim 15 having a duration of at least 10 seconds to one minute to cause the calming effect on the human viewer viewing the motion picture.

17. The motion picture of claim 14, wherein positioning the camera includes mounting the camera on a stable straight track.

18. The motion picture of claim 14, wherein positioning the camera includes mounting the camera on an aircraft.

19. The motion picture of claim 14, wherein moving the camera includes using a motor to move the camera at a constant speed.

20. The motion picture of claim 14, wherein said speed is within a range of approximately one foot per ten seconds when the first distance of the foreground elements from the camera are over three feet.

21. The motion picture of claim 14, wherein said speed is within a range of approximately one foot per forty seconds when the first distance of the foreground elements from the camera is one foot from the camera.

22. The motion picture of claim 14, wherein the capturing captures a wide-angle view through a non-distorting wide-angle lens.

23. The motion picture of claim 14, wherein foreground elements include one or more of a surface, such as a ground surface, or one or more objects, and wherein background elements include a landscape.

24. The motion picture of claim 14, wherein the moving is not level, while the camera is level.
